(19) United States
(12) Patent Application Publication
(10) Pub. No.: US 2016/0075098 A1
(43) Pub. Date: Mar. 17, 2016

(54) BAG FOLDING MACHINE

(71) Applicant: Eric Anthony Link, Jacksonville, AL (US)

(72) Inventor: Eric Anthony Link, Jacksonville, AL (US)

(21) Appl. No.: 14/486,435

(22) Filed: Sep. 15, 2014

(51) Int. Cl. B31B 49/00; B31D 5/04

(52) U.S. Cl. CPC B31B 49/00; B31D 5/04

(57) ABSTRACT

A bag folding apparatus is provided. The bag folding apparatus includes a platform formed to support a bag in an upright position. The present invention may further include an overhead thruster comprising a plurality of fingers extending towards the platform. The overhead thruster is configured to thrust the plurality of fingers towards and away from the platform, and thereby places the plurality of fingers within the bag and removes the plurality of fingers from the bag. The present invention may further include actuators operatively connected to the plurality of fingers. The actuator is operable to move the plurality of fingers from side to side and front to back along a plane substantially parallel with the platform.

### BACKGROUND OF THE INVENTION

The present invention relates to folding bags and, more particularly, to a bag folding machine.

Currently, square bags being filled at a rate of three seconds plus need to be folded and presented to a sealing system. Manual folding is slow, inefficient and inconsistent. Current folding machines are very expensive, inconsistent, slow, difficult to program, with several pneumatic and electronic issues.

As can be seen, there is a need for an improved bag folding machine.

### SUMMARY OF THE INVENTION

In one aspect of the present invention, a bag folding apparatus comprises: a platform formed to support a bag in an upright position; an overhead thruster comprising a plurality of fingers extending towards the platform, wherein the overhead thruster is configured to thrust the plurality of fingers towards and away from the platform; and at least one actuator operatively connected to the plurality of fingers, wherein the actuator is operable to move the plurality of fingers from side to side and front to back along a plane substantially parallel with the platform.

These and other features, aspects and advantages of the present invention will become better understood with reference to the following drawings, description and claims.

### BRIEF DESCRIPTION OF THE DRAWINGS

FIG. 1 is a perspective view of the present invention;

FIG. 2 is a detailed perspective view of the present invention showing the bag manipulation tooling assembly;

FIG. 3 is a detailed section view the present invention taken along line 3-3 in FIG. 1 shown with the fully opened square bag in the starting position on the conveyor belt;

FIG. 4 is a detailed section view of the present invention shown with the square bag in the spread open expanded position.

FIG. 5 is a detailed section view of the present invention shown with the square bag in the partially closed position;

FIG. 6 is a detailed section view of the present invention shown with the square bag in the fully closed compressed position;

FIG. 7 is a detailed section view of the present invention shown with the square bag in the fully closed compressed position and continuing on the conveyor belt; and

FIG. 8: is a flowchart of a method of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a machine to fold the sides of a square bag using pneumatics and electronics. By the use of pneumatic cylinders and electronic controls, the bag is folded, nitrogen purged and delivered to a sealing system. The present invention reduces the amount of moving parts and develops a combination frame using welded materials and aluminum extruded framework.

In certain embodiments, the present invention may include the following components. The steel frame may support the entire machine tooling, cylinders, and control box. The control box contains a power supply, a PLC (programmable logic controller), a VFD (variable frequency drive) for customer's conveyor speed control, and a contactor for customer's conveyor (start/stop). The extruded aluminum frame supports the guided rails, the tooling fingers, and the bag manipulating fingers. The bag stop system is mounted to the steel frame via extruded aluminum and hovers over the conveyor belt. The thruster is a large, guided, pneumatic cylinder that is bolted to the top of the steel frame and is controlled via the PLC. The “front/back” spread cylinders are controlled via the

PLC and control the position of the fingers from the front to the back of the bag once the thruster lowers the tooling to the bag. The corners, spread cylinders open the bag to all four corners once the spread cylinders have completed their task. The gusseting cylinders fold the bag from the outside ends after the corner cylinders have completed their task. The front/back spread cylinders are deactivated at this point allowing the bag to be “re-gusseted”. The bag clamps are activated at this point to hold the bag closed while the thruster and bag stop are deactivated. This allows the bag to remain closed while being transferred to the customer's bag sealing system.

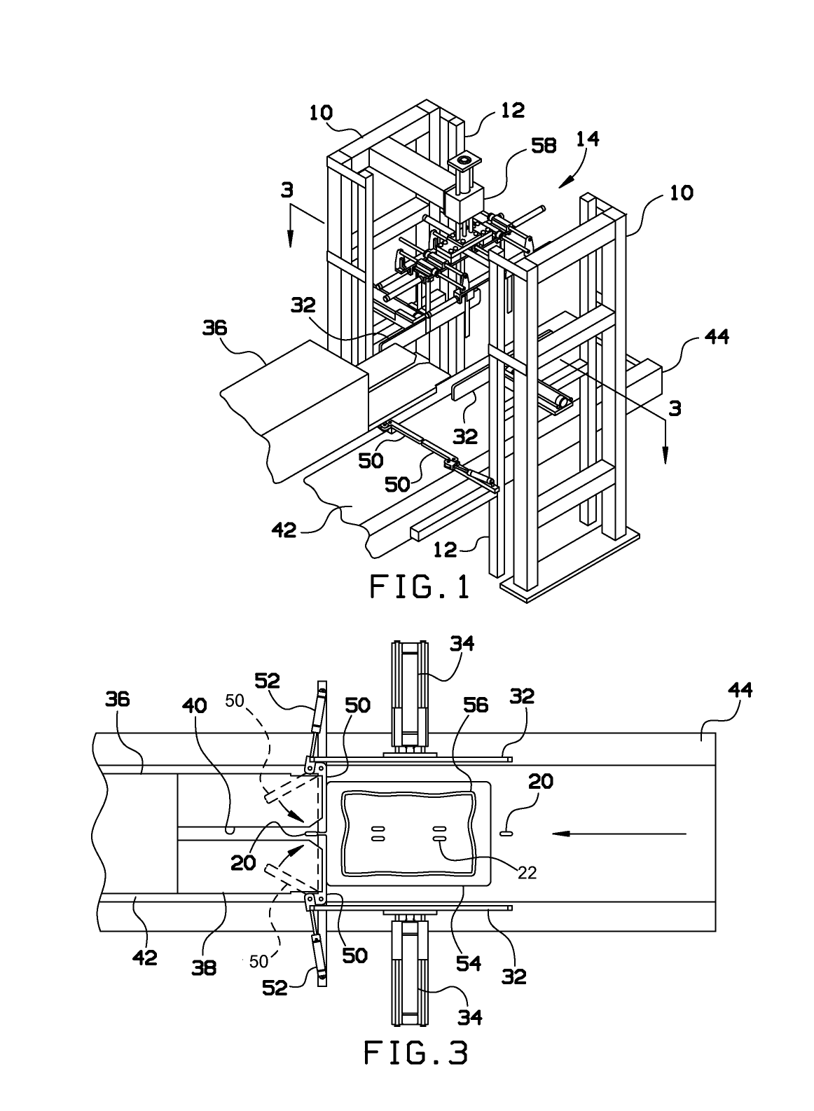

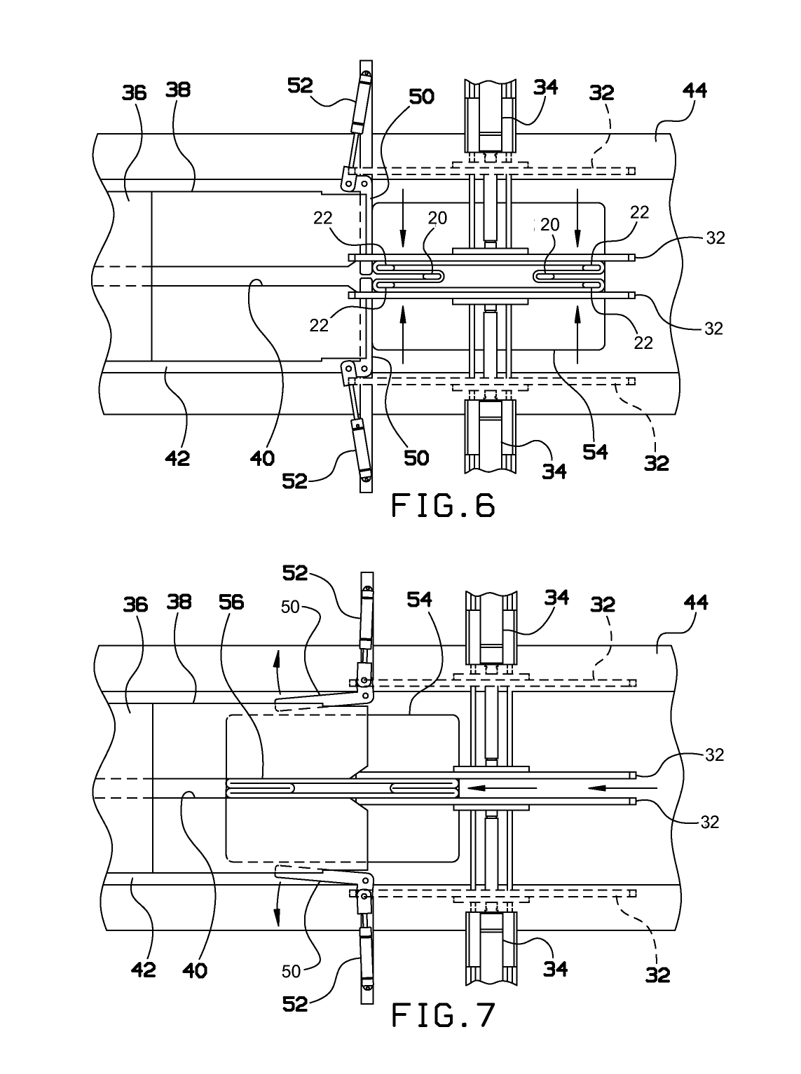

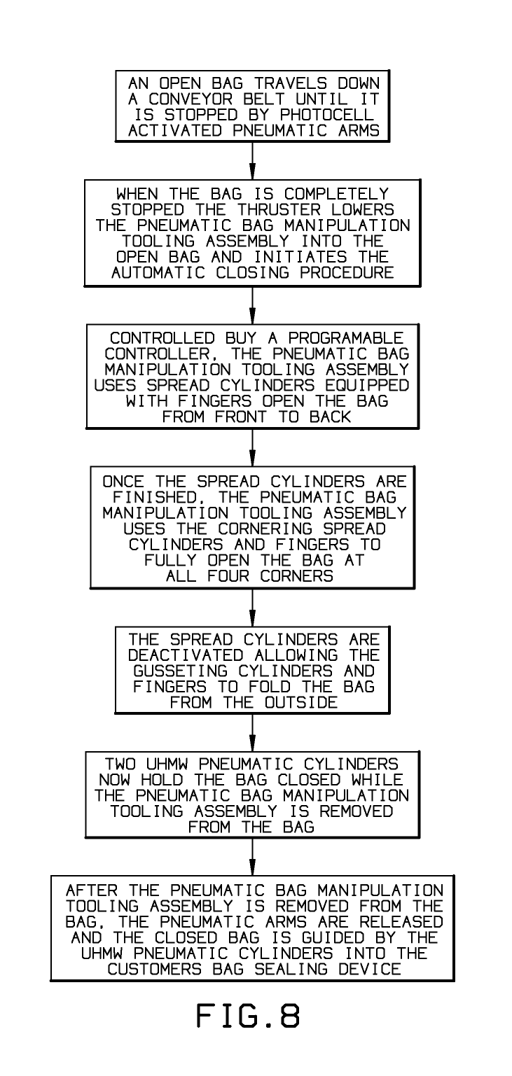

Referring to FIGS. 1 through 8, the present invention includes a bag folding apparatus. The bag folding apparatus includes a platform 44 formed to support a bag 54 in an upright position. The present invention may further include an overhead thruster 58 comprising a plurality of fingers 20, 22 extending towards the platform 44. The overhead thruster 58 is configured to thrust the plurality of fingers towards and away from the platform 44, and thereby places the plurality of fingers 20, 22 within the bag 54 and removes the plurality of fingers 20, 22 from the bag. The present invention may further include actuators 60, 62 operatively connected to the plurality of fingers. The actuator 60, 62, 64 is operable to move the plurality of fingers 20, 22 from side to side and front to back along a plane substantially parallel with the platform 44.

Referring to FIG. 1, the present invention may be supported by a welded mainframe 10, made out of a strong metal such as steel. The mainframe 10 may include an extruded inset frame 12 to support the platform 44. The welded mainframe 10 may further support the overhead thruster 58 above the platform 44. In certain embodiments, the platform may include a conveyor belt 42. A pair of stop arms 50 may be used to stop a bag 54 on the platform below the overhead thruster 58 so that the bag 54 may be properly folded. A bag sealing device 36 may be positioned on the conveyor so that the stop arms 50 are in between the bag sealing device 36 and the bag holding and folding position of the platform 44. Therefore, once the bag 56 has been folded, the stop arms 50 may pivot so that the folded bag is released and enters enter the sealing device 36.

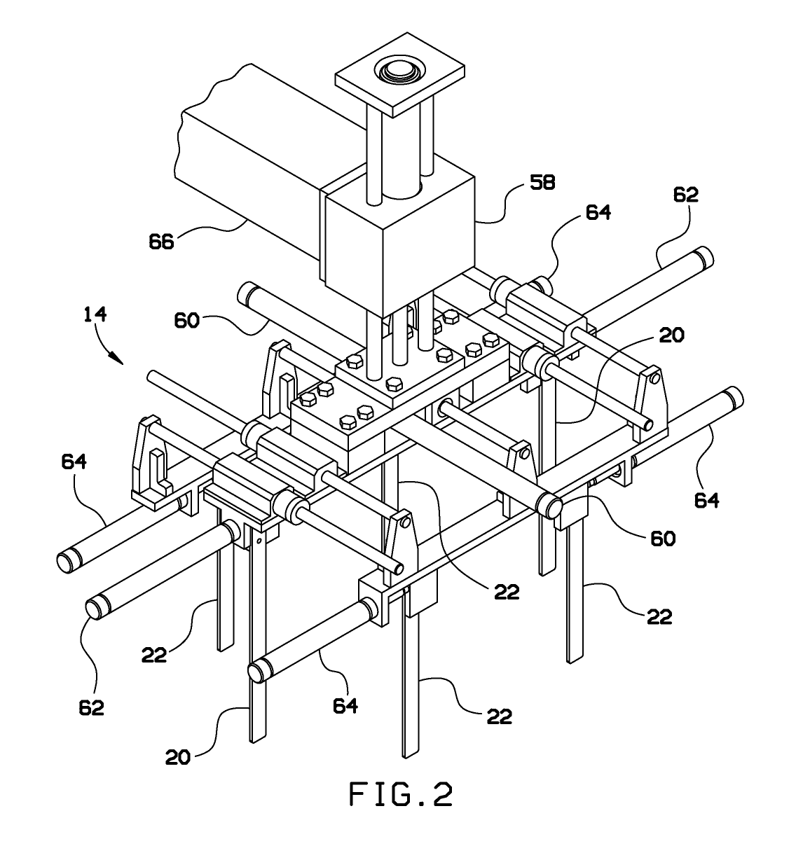

Referring to FIG. 2, the present invention includes a bag manipulation tooling assembly 14. The tooling assembly 14 may include the overhead thruster 58 and the plurality of fingers 20, 22. The overhead thruster 58 may be attached to the mainframe 44 by a frame arm 66. The plurality of fingers 20, 22 may include four cornering fingers 22 including a first pair and a second pair and two gusset fingers 20. The cornering fingers 22 may be driven front to back by cornering pneumatic cylinders 60 and side to side by spreading pneumatic cylinders 64. The gusset fingers 20 may be driven side to side by the gusseting pneumatic cylinders 62.

The unfolded bag 54 may run along the conveyor 42 and may be stopped by the closed stop arms 50. The unfolded bag 54 may include a top opening 56 and may be a square bag 54. The plurality of fingers 20, 22 may start at a compressed position. As illustrated in FIG. 3, once the unfolded bag 54 has reached the closed stop arms 50, the overhead thruster 58 may lower the plurality of fingers 20, 22 so that the cornering fingers are within the bag 54 near the center and the gusset fingers 20 are positioned on an outer perimeter on opposite sides of the bag 54. The cornering fingers 22 may then move to an expanded position and back to a compressed position to fold the bag 54.

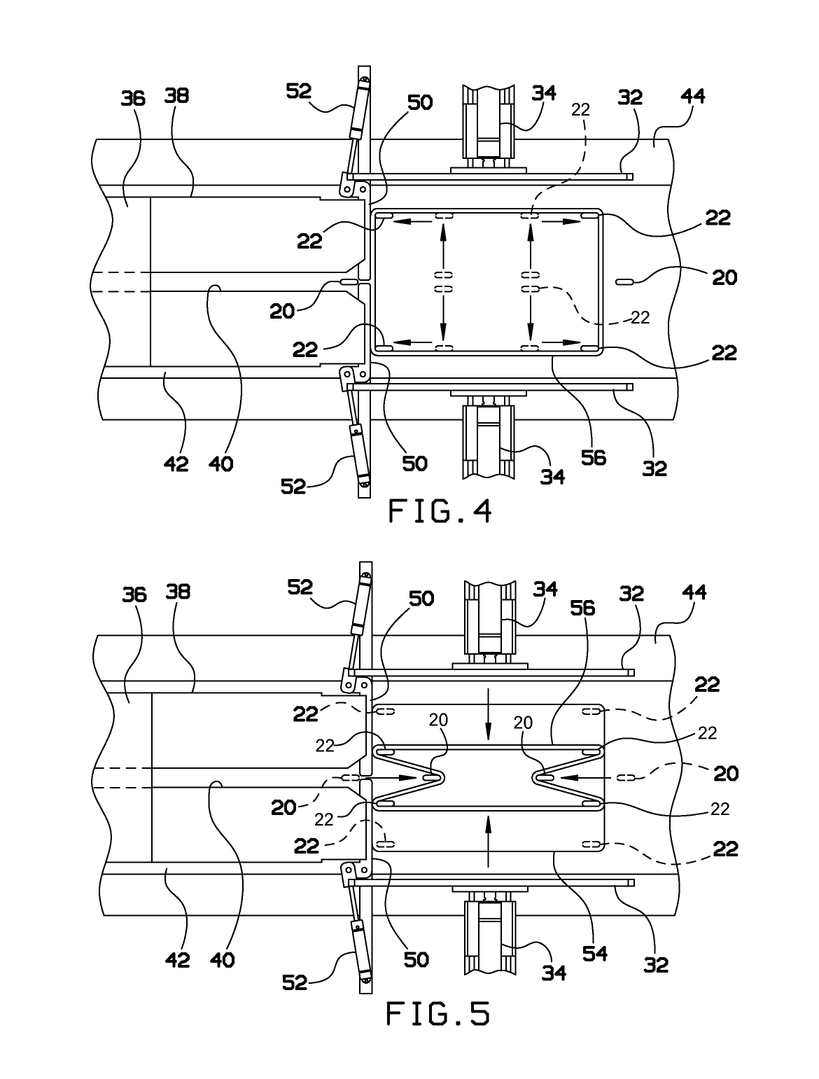

As illustrated in FIG. 4, the cornering fingers 22 may be expanded to stretch the bag so that each finger 22 is located at a corner of the bag 54. The gusset fingers 20 may move towards one another and the first pair of cornering fingers 22 may move towards one another and the second pair of cornering fingers 22 may move towards one another, thereby folding the bag 54 to a compressed form.

In certain embodiments, the present invention may further include clamping members 32 that are activated by pneumatic thrusters 34. The clamping members 32 may be on opposite sides of the platform 44 and substantially parallel to the first pair and the second pair of cornering fingers 22. Once the bag 54 has been folded the clamping members 32 may be actuated towards one another, securing the folded bag 54 in between. Once the clamping members 32 secure the folded bag, the plurality of fingers 20, 22 may be removed by the overhead thruster 58 rising away from the platform 44.

Once the plurality of fingers 20, 22 is removed from the folded bag 54, the closed stop arms 50 may open. The stop arms 50 may be actuated by pneumatic cylinders 52 to pivot the arms away from one another. The conveyor belt 44 may convey the folded bag 54 to a bag guide 38 having a bag guide slot 40. The bag guide slot 40 may guide the folded bag 54 into the bag sealing device 36. Therefore, the bag sealing device 36 may seal the folded bag 54 for shipping.

A method of using the present invention may include the following. If the photo sensor is blocked, actuate the stop arms. Once the bag is stopped by the stop arms, actuate the thruster based on a settable time delay. After the thruster is actuated, actuate the front/back spread of the fingers, based on a settable time delay. After the front/back spread is actuated, actuate the corners spread of the fingers based on a settable time delay. After the corners spread is actuated, actuate the gussets, based on a settable time delay. De-actuate the front/back spread of the corner fingers after the gussets have actuated based on a settable time delay. Actuate the bag clamps based on a settable time delay. De-actuate the thruster and the stop arms release the bag and hold it closed until the bag enters the customer's sealing system based on a settable time delay. After the folding and release has been completed, the functions may be at a zero state based on a settable time delay.

It should be understood, of course, that the foregoing relates to exemplary embodiments of the invention and that modifications may be made without departing from the spirit and scope of the invention as set forth in the following claims.

What is claimed is:

1. A bag folding apparatus comprising:
a platform formed to support a bag in an upright position;
an overhead thruster comprising a plurality of fingers extending towards the platform, wherein the overhead thruster is configured to thrust the plurality of fingers towards and away from the platform; and
at least one actuator operatively connected to the plurality of fingers, wherein the actuator is operable to move the plurality of fingers from side to side and front to back along a plane substantially parallel with the platform.

2. The bag folding apparatus of claim 1, wherein the plurality of fingers comprises four cornering fingers comprising a first pair and a second pair and two gusset fingers, wherein the four cornering fingers and the two gusset fingers comprise an expanded position and a compressed position.

3. The bag folding apparatus of claim 2, wherein the expanded position comprises the four cornering fingers inserted into an opening of a bag and moving to a position in which each of the cornering fingers is located at a corner of the bag, and the two gusset fingers are positioned on an outer perimeter on opposite sides of the bag.

4. The bag folding apparatus of claim 3, wherein the compressed position comprises the two gusset fingers moving towards one another and the first pair moving towards one another and the second pair moving towards one another, thereby folding at least a top of the bag to a compressed form.

5. The bag folding apparatus of claim 4, further comprising clamping members on opposite sides of the platform and substantially parallel to the first pair and the second pair, wherein the clamping members are operable to clamp at least the folded top of the bag.

6. The bag folding apparatus of claim 5, further comprising a conveyor belt disposed on the platform.

7. The bag folding apparatus of claim 1, further comprising at least one pivoting stop arm operable to position a bag on the platform to be folded, and operable to release the bag once the bag is folded.

8. The bag folding apparatus of claim 1, further comprising a bag guide comprising a bag guide slot operable to receive a folded bag.

9. The bag folding apparatus of claim 8, further comprising a bag sealing device operable to receive the folded bag from the bag guide and seal a folded top of the bag.

10. The bag folding apparatus of claim 1, wherein the overhead thruster and the at least on actuator are pneumatic cylinders.
